(19) United States
(12) Patent Application Publication
(10) Pub. No.: US 2012/0273476 A1
(43) Pub. Date: Nov. 1, 2012

(54) BEVERAGE VENDING MACHINE

(75) Inventor: Dan Alexie Sirbu Villa, Bonate Sotto (IT)

(73) Assignee: N&W GLOBAL VENDING S.P.A., Valbrembo (IT)

(21) Appl. No.: 13/148,557

(22) PCT Filed: Feb. 11, 2010
(86) PCT No.: PCT/IB2010/000263

§ 371 Date: Nov. 14, 2011

(30) Foreign Application Priority Data
Feb. 13, 2009 (IT) TO2009A 000104

(51) Int. Cl. F27D 11/00

(52) U.S. Cl. 219/385

(57) ABSTRACT

A beverage vending machine having a cabinet closed by a door; a supporting surface housed inside the cabinet; a number of containers for soluble material, located on the supporting surface; and a number of heating devices, each of which is incorporated in a locking member for locking the container to the supporting surface, and has an electric resistor.

### CROSS-REFERENCE TO RELATED APPLICATIONS

This application is a U.S. Nationalization of PCT International Application No. PCT/IB2010/000263, filed Feb. 11, 2010, entitled “BEVERAGE VENDING MACHINE”, which claims priority to Italian Patent Application No. TO2009A000104, filed Feb. 13, 2009, the entireties of both of the foregoing application are incorporated herein by reference.

### TECHNICAL FIELD

Embodiments of the present invention relate to a beverage vending machine.

More specifically, embodiments of the present invention relate to a beverage vending machine of the type comprising a cabinet; a supporting surface housed inside the cabinet; at least one container located on the supporting surface and for housing a soluble material; at least one heating device, in turn comprising a heat source connected to the supporting surface and located under the container; and a locking member connected rigidly to the supporting surface to lock the container, in use, to the supporting surface.

### BACKGROUND ART

A vending machine is described, for example, in U.S. Pat. No. 2,755,000.

Not withstanding the heat source, a common drawback of known vending machines of the above type is failure to prevent the steam in the cabinet from binding the soluble material in the container, and so clogging the dispensing device—normally a powered screw—normally located at the bottom of the container.

### SUMMARY

One or more embodiments of the present invention provide a beverage vending machine designed to eliminate the above drawback in a straightforward, low-cost manner.

According to an embodiment the present invention, there is provided a beverage vending machine having a cabinet; a supporting surface housed inside the cabinet; a number of containers for soluble material located on the supporting surface; and a number of heating devices, each of which is incorporated in a locking member for locking the container to the supporting surface, and has an electric resistor.

### BRIEF DESCRIPTION OF THE DRAWINGS

A non-limiting embodiment of the present invention will be described by way of example with reference to the accompanying drawings, in which:

FIG. 1 shows a three-quarter top view in perspective, with parts removed for clarity, of a preferred embodiment of the machine according to an embodiment of the present invention;

FIG. 2 shows a larger-scale detail of FIG. 1, with parts removed for clarity;

FIG. 3 shows a larger-scale axial section of a detail in FIG. 1;

FIG. 4 shows a larger-scale detail of FIG. 3;

FIG. 5 shows an exploded view in perspective of the FIG. 4 detail.

### DETAILED DESCRIPTION

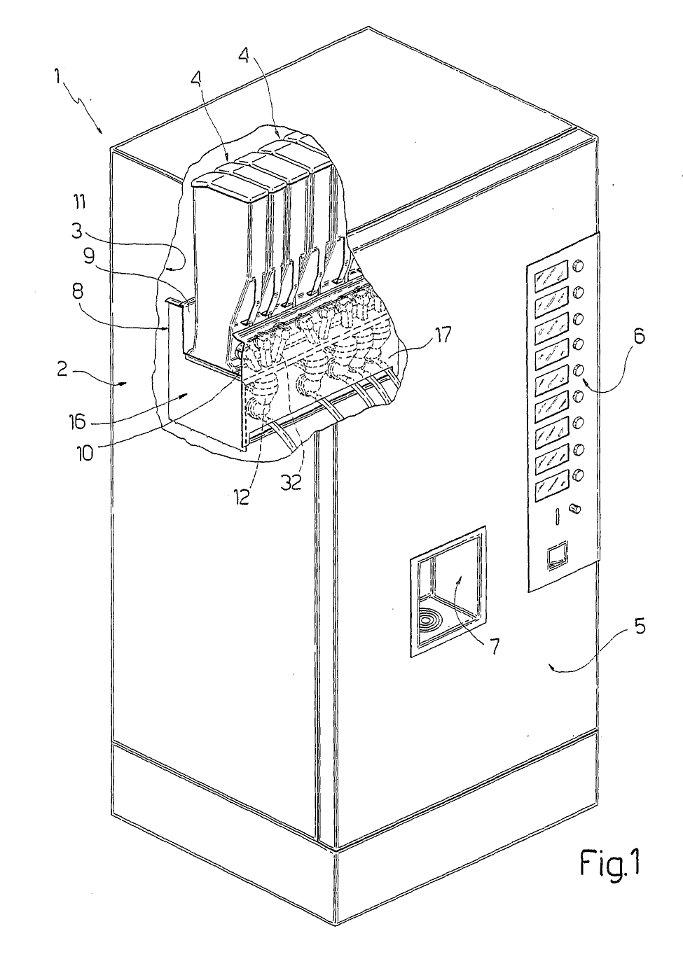

Number 1 in FIG. 1 indicates as a whole a beverage vending machine, in particular for hot or cold so-called “instant” beverages made from a measure of soluble material.

Machine 1 comprises a cabinet 2 defining a compartment 3, which houses a number of assemblies 4 for producing respective beverages, and is closed at the front by a door 5 comprising a beverage selection button panel 6, and a dispenser recess 7 from which the user withdraws a cup (not shown) of the selected beverage.

Inside compartment 3, assemblies 4 are fitted to a frame 8 connected rigidly to cabinet 2 and comprising a vertical wall 9 facing a rear wall of cabinet 2; and a horizontal wall 10 substantially perpendicular to and integral with vertical wall 9, and extending from vertical wall 9 towards door 5.

Wall 10 defines a supporting surface for assemblies 4, each of which comprises one or more containers 11 of soluble material; and a known mixer 12 located, with the other mixers 12, under wall 10 and facing door 5.

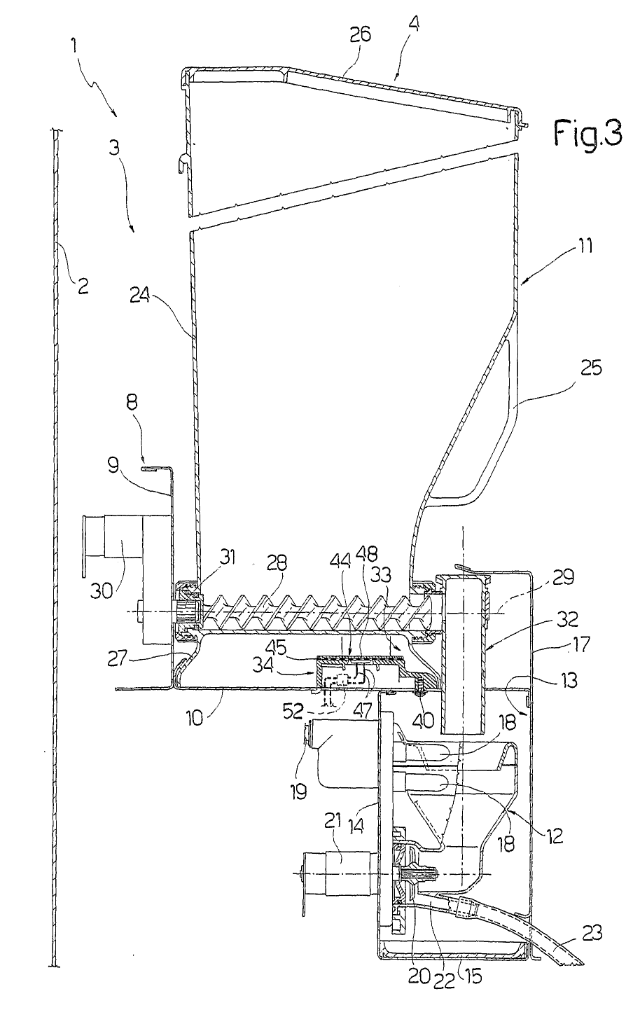

More specifically, and as shown in FIGS. 1 and 3, mixers 12 are housed side by side inside a cell 13, which is defined by a wall 14 connected rigidly to wall 10 and supporting mixers 12, by a bottom wall 15, and by two lateral walls 16 (only one shown in FIG. 1), and has a front opening facing door 5 and fitted with a hatch 17. In one variation, one or each wall 16 may be replaced by the corresponding lateral wall of machine 1.

Each mixer 12 is funnel-shaped, and comprises a top inlet communicating with two pressurized-water inlets 18 connected to the delivery of a pump (not shown), and with a steam suction conduit 19; and a narrow bottom portion, which houses a blending impeller 20 operated, in use, by an electric motor 21 fitted to wall 14, and has a beverage outflow conduit 22 communicating with the outside by a delivery hose 23.

As shown in FIG. 3, each container 11 comprises a tank 24 for housing soluble material, has a front handle 25 for easy removal and refill by an operator, and is closed at the top by a removable cover 26, and at the bottom by a cup-shaped base 27 facing downwards and resting on wall 10.

At the bottom of tank 24, container 11 comprises a material dispensing device, in turn comprising a screw 28 coaxial with an axis 29 substantially parallel to wall 10 and substantially perpendicular to wall 9. Screw 28 is operated, in use, by an electric motor 30, which is fitted to wall 9 and comprises an output shaft 31 extending through the lateral wall of container 11 and connected angularly to the rear end of screw 28 by a known fast-fit face coupling.

The opposite free end of screw 28 engages an inlet conduit of a known spout 32 fitted to the lateral wall of container 11 and having an outlet conduit, which extends downwards, perpendicularly to axis 29, through wall 10 to the inlet of relative mixer 12.

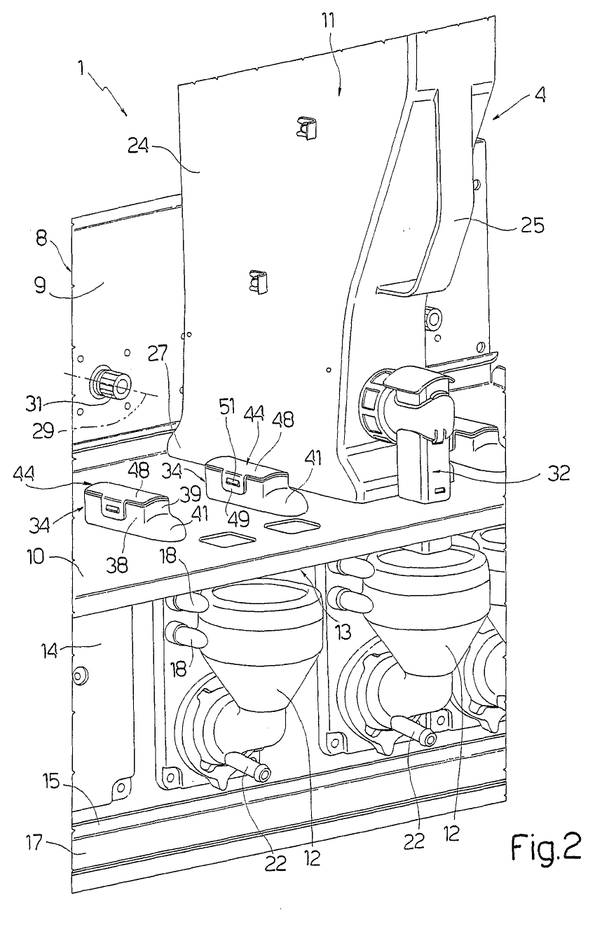

As shown in FIGS. 2 and 3, to lock containers 11 removably to wall 10, cup-shaped base 27 of each container 11 is shaped internally to define, close to its front, a straight guide 33 substantially parallel to axis 29, and which, when assembling relative container 11, is engaged in sliding manner by a respective locking member which, together with straight guide 33, forms a removable plug-socket coupling and is defined by an elongated body 34 fitted to wall 10 and aligned with output shaft 31 of relative electric motor 30.

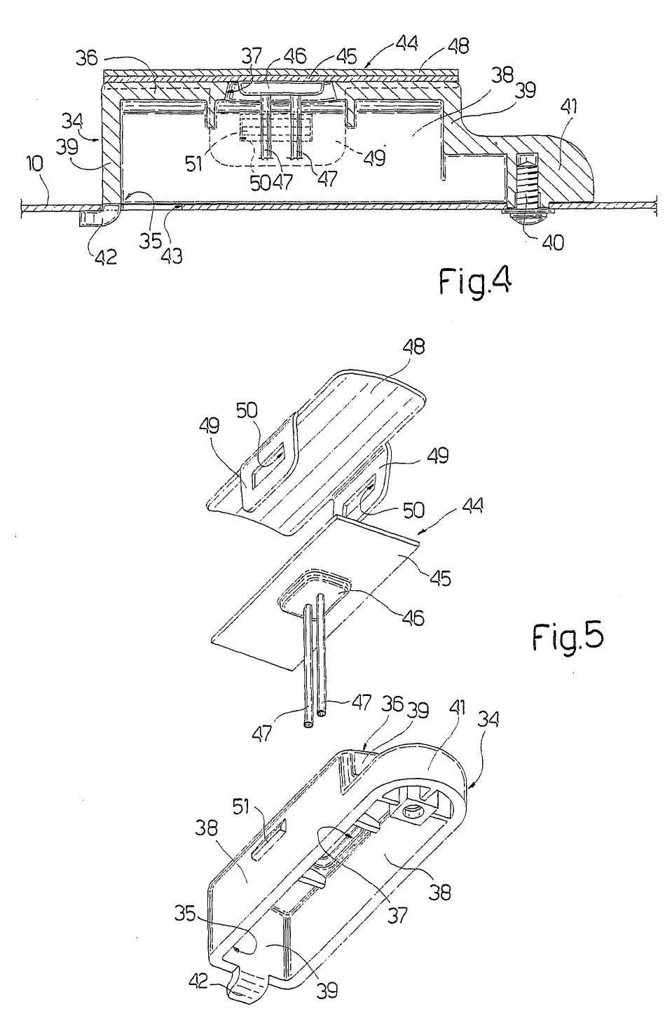

As shown more clearly in FIGS. 4 and 5, body 34 is in the form of a substantially parallelepiped-shaped shell having a bottom opening 35 and bounded laterally by an outwardly convex top wall 36 with a central through hole 37, by two longitudinal sides 38 substantially parallel to each other and to axis 29, and by two substantially parallel transverse sides 39 generally perpendicular to longitudinal sides 38. Body 34 is fastened to wall 10 by a screw 40 engaging a threaded hole perpendicular to axis 29 and formed through a rounded appendix 41 projecting axially from the transverse side 39 facing spout 32. In addition to the screw fastener, and to keep body 34 aligned, in use, with output shaft 31 of relative electric motor 30, the free edge of the transverse side 39 opposite appendix 41 has an L-shaped appendix 42 which, when assembling body 34, and before inserting screw 40, is inserted through a hole 43 formed through wall 10, and is positioned resting against a free edge of hole 43, so as to extend towards wall 9 and contact the underside of wall 10.

To prevent the soluble material from binding in the area of each tank 24 surrounding relative screw 28, machine 1 comprises, for each container 11, a heating device 44 incorporated in relative body 34.

As shown in FIGS. 4 and 5, each heating device 44 comprises a heat source defined by an electric resistor 45 in the form of a rectangular metal sheet, which covers the outer surface of top wall 36 and has a central projection 46, which engages hole 37, and from which project two electric terminals 47.

Resistor 45 is held contacting top wall 36 by a metal plate 48, which forms part of heating device 44, is substantially the same shape and size as top wall 36, and has two wings 49, which project downwards from respective free longitudinal edges of plate 48, and each of which has a slot 50, into which clicks a respective tooth 51 integral with a relative longitudinal side 38 of body 34.

In a preferred embodiment, to stabilize resistor 45 and improve heat transmission between resistor 45 and plate 48, resistor 45 is glued beforehand to the inner surface of plate 48 using heat-conducting glue.

As shown in FIG. 3, terminals 47 are connected to an electric circuit of machine 1 by a known connector 52, preferably housed inside body 34.

In one variation, only some of bodies 34 incorporate respective heating devices 44, and the other bodies 34 are each closed at the top by a top wall 36 with no central hole 37.

The advantages of employing bodies 34 incorporating respective heating devices 44 will be clear from the above description. More specifically, an extremely simple, compact, low-cost structure provides for effectively heating containers 11, on account of the heat released by each resistor 45 not only spreading to the area around containers 11, but also concentrating in the area around screw 28, where the soluble material is compacted most, and so has a greater tendency to bind.

1) A beverage vending machine, comprising,
a cabinet;
a supporting surface housed inside of the cabinet;
at least one container located on the supporting surface and for housing a soluble material, the at least one container including a hollow base;
at least one heating device in turn comprising a heat source connected to the supporting surface and located under the at least one container; and
a locking member connected rigidly to the supporting surface to lock the at least one container, in use, to the supporting surface;
wherein the locking member comprises a body, which supports the heat source, projects from the supporting surface towards the at least one container, and is engaged by the hollow base of the at least one container to form a removable plug-socket coupling.

2) The machine as claimed in claim 1, wherein the heat source comprises an electric resistor.

3) The machine as claimed in claim 1, wherein the body has a top wall; the heat source comprising an electric resistor defined by a metal sheet on the top wall.

4) The machine as claimed in claim 3, wherein the at least one heating device comprises a metal plate connected firmly to the top wall with the interposition of the electric resistor.

5) The machine as claimed in claim 4, wherein the electric resistor is glued to the metal plate.

6) The machine as claimed in one of the foregoing claim 1, wherein the at least one container comprises a number of containers arranged side by side on the supporting surface; and wherein the at least one heating device comprises a number of heating devices, each associated with a respective one of the number of containers.

7) A heating device as claimed in claim 1.
